(19) United States
(12) Patent Application Publication
(10) Pub. No.: US 2026/0029996 A1
(43) Pub. Date: Jan. 29, 2026

(54) SYSTEMS AND METHODS FOR AUTOMATED CODE GENERATION USING INTERFACE DEFINITION LANGUAGE

(71) Applicant: TOYOTA JIDOSHA KABUSHIKI KAISHA, Aichi-ken (JP)

(72) Inventors: Michael Joseph Lowe, Tokyo (JP); Daniel Felix Nguyen Olbrys, Tokyo (JP)

(73) Assignee: TOYOTA JIDOSHA KABUSHIKI KAISHA, Aichi-ken (JP)

(21) Appl. No.: 18/782,137

(22) Filed: Jul. 24, 2024

(51) Int. Cl. G06F 8/35

(52) U.S. Cl. CPC G06F 8/35

(57) ABSTRACT

Provided are a system, apparatus, and method for generating codes. The method may include, receiving an interface definition language (IDL) file and a high-level rule file; converting the high-level rule file into a low-level rule file; determining whether the IDL file complies with the low-level rule file; and based on determining that the IDL file complies with the low-level rule file, generating code based on the IDL file.

Systems and methods consistent with example embodiments of the present disclosure relate to automated code generation using interface definition language (IDL).

### BACKGROUND

In the related art, interface definition language (sometimes also referred to as an Interface Definition Language; IDL) is a descriptive language which may be used to define a data type and interface independent of a base operating system (OS)/programming language. In this regard, an interface may be defined using the IDL, and may be converted into the base OS/programming language (for example, like C, C++. Java). This may allow the user to define the data types/interface in a language-independent way, and may allow for a bridge between two different operating systems/programming languages.

Typically, the related art may not use dynamic memory allocation for defined data-types for IDL's. This may be of pertinence to cases where the IDL is being used for applications involved in safety-critical situations. For instance, for applications in the automotive industry, the sensors on a vehicle may require a specific level of precision, or a specific number of datapoints need to be collected in order to ensure operation of the application is within the safety standard. In this regard, if a static data allocation (e.g., string with max size 5 or array with max size 8) is defined, there may be possibility that overflow may occur, or inadvertently data precision or data points are truncated. Meanwhile, if the memory allocation was set to be statically high, it may be inefficient and consume too much memory.

In addition, the related art may not consider how to create restrictions related to safety-critical situations. The related art, at best, may consider how to verify an IDL file using a verification program against a pre-determined set of rules, but the pre-determined set of rules (which are low-level and concrete) may not clearly map to a safety standard, which encompasses a more high-level and abstract set of limitations.

Accordingly, there is a need for an IDL which can adapt to safety-critical situations and safety standards.

### SUMMARY

According to one or more example embodiments, apparatuses and methods are provided for automated code generation using interface definition language (IDL). In particular, apparatuses and methods according to example embodiments may include receiving an interface definition language (IDL) file (which may have at least one defined data/interface-type with dynamic memory allocation) and a high-level rule file (such as a safety standard); converting the high-level rule file into a low-level rule file (for example, using machine learning (ML) model); determining whether the IDL file complies with the low-level rule file; and based on determining that the IDL file complies with the low-level rule file, generating code based on the IDL file.

Accordingly, by using dynamic memory allocation for data types/interfaces in the IDL file, safety-critical scenarios which require a specific data precision/number of data points can be encompassed. In addition, since more abstract rules (which may encompass a safety standard) can be defined in a high-level rule file, the user can more easily map the IDL file to be in compliance with their ruleset.

According to embodiments, a method for generating code may be provided, the method including receiving an interface definition language (IDL) file and a high-level rule file; converting the high-level rule file into a low-level rule file; determining whether the IDL file complies with the low-level rule file; and based on determining that the IDL file complies with the low-level rule file, generating code based on the IDL file.

According to embodiments, the IDL file may include at least one data-type or interface with dynamic memory allocation.

Converting the high-level rule file into a low-level rule file comprises interpreting the high-level rule file using a machine learning model. The high-level rule file may include a safety standard document. The low-level rule file may include at least one rule of an element or a combination of elements which cannot be included in the IDL file. The low-level rule file may include at least one rule of a boundary which cannot be exceeded in the IDL file.

According to embodiments, the method may further include based on determining that the IDL file does not comply with the low-level rule file, sending a warning message.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 is a diagram of example components of a device according to an example embodiment;

FIG. 2 is a block diagram showing example interface definition language (IDL) file and rule files according to one or more example embodiments;

FIG. 3 is a block diagram showing an example system architecture for generating code based on an IDL file and rule files according to one or more example embodiments; and

FIG. 4 is a flowchart diagram showing a method generating code based on an IDL file and rule file according to one or more example embodiments.

### DETAILED DESCRIPTION

The following detailed description of example embodiments refers to the accompanying drawings. The disclosure provides illustration and description, but is not intended to be exhaustive or to limit one or more example embodiments to the precise form disclosed. Modifications and variations are possible in light of the disclosure or may be acquired from practice of one or more example embodiments. Further, one or more features or components of one example embodiment may be incorporated into or combined with another example embodiment (or one or more features of another example embodiment). Additionally, in the flowcharts and descriptions of operations provided herein, it is understood that one or more operations may be omitted, one or more operations may be added, one or more operations may be performed simultaneously (at least in part), and the order of one or more operations may be switched.

It will be apparent that example embodiments of systems and/or methods and/or non-transitory computer readable storage mediums described herein may be implemented in different forms of hardware, firmware, or a combination of hardware and software. The actual specialized control hardware or software code used to implement these systems and/or methods is not limiting of one or more example embodiments. Thus, the operation and behavior of the systems and/or methods and/or non-transitory computer readable storage mediums are described herein without reference to specific software code. It is understood that software and hardware may be designed to implement the systems and/or methods based on the descriptions herein.

Even though particular combinations of features are recited in the claims and/or disclosed in the specification, these combinations are not intended to limit the disclosure of possible example embodiments. In fact, many of these features may be combined in ways not specifically recited in the claims and/or disclosed in the specification. Although each dependent claim listed below may directly depend on only one claim, the disclosure of possible example embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open- ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Apparatuses and methods consistent with the inventive concept(s) provide a process for generating code using interface definition language (IDL). In particular, apparatuses and methods according to example embodiments may include receiving an interface definition language (IDL) file (which may have at least one defined data/interface-type with dynamic memory allocation) and a high-level rule file (such as a safety standard); converting the high-level rule file into a low-level rule file (for example, using machine learning (ML) model); determining whether the IDL file complies with the low-level rule file; and based on determining that the IDL file complies with the low-level rule file, generating code based on the IDL file.

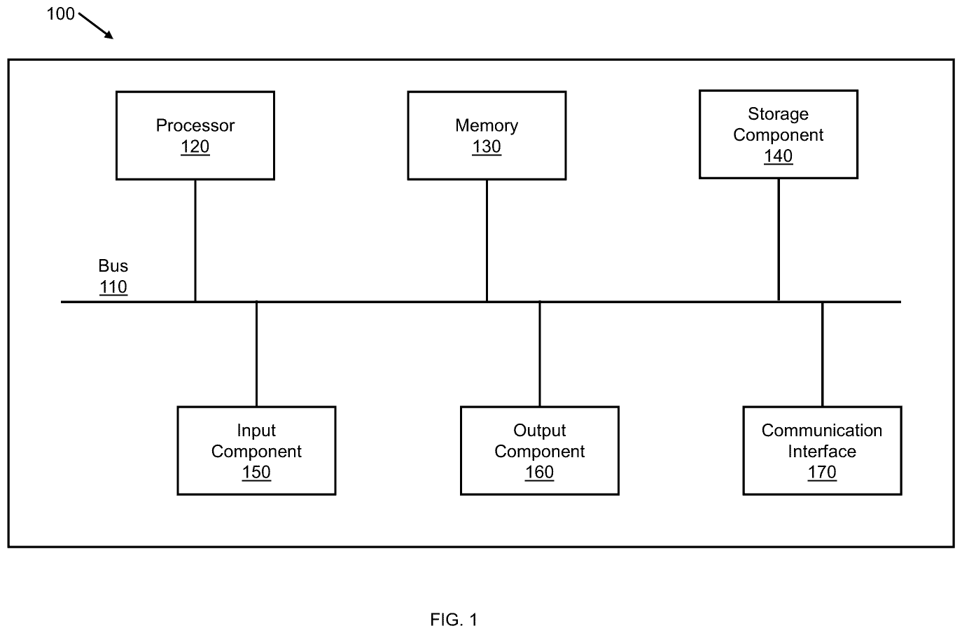

FIG. 1 is a diagram of example components of a device 100. As shown in FIG. 1 device 100 may include a bus 110, a processor 120, a memory 130, a storage component 140, an input component 150, an output component 160, and a communication interface 170.

Bus 110 includes a component that permits communication among the components of device 100. The processor 120 may be implemented in hardware, firmware, or a combination of hardware and software. Processor 120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In one or more example embodiments, the processor 120 includes one or more processors capable of being programmed to perform a function. The memory 130 includes a random access memory (RAM), a read only memory (ROM), and/or another type of dynamic or static storage device (e.g., a flash memory, a magnetic memory, and/or an optical memory) that stores information and/or instructions for use by the processor 220.

Storage component 140 stores information and/or software related to the operation and use of device 100. For example, the storage component 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 150 includes a component that permits device 100 to receive information, such as via user input (e.g., a touch screen display, a keyboard, a keypad, a mouse, a button, a switch, and/or a microphone). Additionally, or alternatively, input component 150 may include a sensor for sensing information (e.g., a global positioning system (GPS) component, an accelerometer, a gyroscope, and/or an actuator). Output component 160 includes a component that provides output information from device 100 (e.g., a display, a speaker, and/or one or more light-emitting diodes (LEDs)).

The communication interface 170 includes a transceiver-like component (e.g., a transceiver and/or a separate receiver and transmitter) that enables device 100 to communicate with other devices, such as via a wired connection, a wireless connection, or a combination of wired and wireless connections. The communication interface 170 may permit the device 100 to receive information from another device and/or provide information to another device. For example, the communication interface 170 may include, but is not limited to, an Ethernet interface, an optical interface, a coaxial interface, an infrared interface, a radio frequency (RF) interface, a universal serial bus (USB) interface, a Wi-Fi interface, a cellular network interface, or the like.

The device 100 may perform one or more example processes described herein. According to one or more example embodiments, the device 100 may perform these processes in response to the processor 120 executing software instructions stored by a non-transitory computer-readable medium, such as the memory 130 and/or the storage component 140. A computer-readable medium is defined herein as a non-transitory memory device. A memory device includes memory space within a single physical storage device or memory space spread across multiple physical storage devices.

Software instructions may be read into the memory 130 and/or the storage component 140 from another computer-readable medium or from another device via the communication interface 170. When executed, software instructions stored in the memory 130 and/or the storage component 140 may cause the processor 120 to perform one or more processes described herein.

Additionally, or alternatively, hardwired circuitry may be used in place of, or in combination with, software instructions to perform one or more processes described herein. Thus, one or more example embodiments described herein are not limited to any specific combination of hardware circuitry and software.

The number and arrangement of components shown in FIG. 1 are provided as an example. In practice, the device 100 may include additional components, fewer components, different components, or differently arranged components than those shown in FIG. 1. Additionally, or alternatively, a set of components (e.g., one or more components) of the device 100 may perform one or more functions described as being performed by another set of components of the device 100.

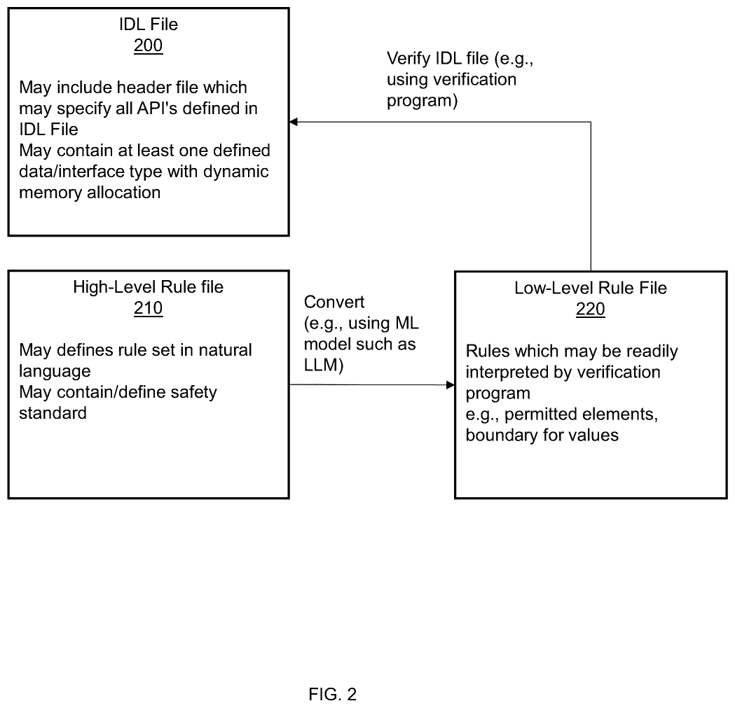

FIG. 2 is a block diagram showing example interface definition language (IDL) file and rule files according to one or more example embodiments. IDL file 200, high-level rule file 210, and low-level rule file 220 may be provided, according to embodiments.

According to embodiments IDL file 200 may be provided and used to define data- types and interfaces based on pre-determined syntax. According to embodiments, IDL file 200 may have a corresponding header file, which may specify all API's defined in the IDL file. The IDL file may be in a format such as, but not limited to, XML.

Implemented data-types or interfaces in the IDL may include dynamically-sized structures (e.g., in order to implement dynamic memory allocation). Accordingly, scenarios where specific levels of precision or data points are required (such as safety-critical scenarios) can be encompassed, while ensuring minimal memory consumption, and avoiding overflow.

Data-types may include, but are not limited to, fixed-width integers (int8, uint8, int16, uint16, int32, uint32, int64, uint64), fixed-width floating point (float32, float64), boolean, void, byte, strings (with fixed, dynamically sized, or dynamically sized with bounded max), void, dynamic array with bounded size N, fixed size array with size N, dynamically size string with bounded size N, general multidimensional arrays, etc.

Some examples of syntax which may be used to define the dynamically-sized structures is as follows:
int8[10][<=5][3]//a multi-dimensional (3D) array of size 10 whose elements are dynamically sized arrays of size maximum 5 whose elements are arrays of signed 8 bit integers of size 3.
string(<=5)[10]//a fixed sized array of size 10 of dynamically sized strings of size maximum 5 byte
string(<=5)[<=10]//a dynamically sized array of size maximum 10 of dynamically sized strings of a maximum size of 5 byte
string(<=3)[10][<=5][4]//a multi-dimensional (3D) array of size 10 whose elements are dynamically sized arrays of size maximum 5 whose elements are arrays of size 4 composed of dynamically sized strings with a maximum size of 3

According to embodiments, a high-level rule file 210 may be provided. High-level rule file 210 may define a set of rules in more abstract terms which cannot be readily interpreted by a verification program. For example, high-level rule file 210 may be written in natural language (language which can be readily interpreted by a human user). According to some embodiments, high-level rule file 210 may be a list/array of rules written in natural language. In some instances, high-level rule file may be a safety standard file, which can define, for example, unit conversions (e.g., miles per hour cannot be used and must be converted to km per hour), necessary levels of precision for certain processes in the application (e.g., at least ten data points must be collected from an accelerometer sensor for the sensor interface), and other interactions which must be included (e.g., a brake sensor interface for a vehicle must collect both timing and braking force data).

According to some embodiments, the format of high-level rule file 210 may be a text file. According to embodiments, it may be an image such as a PDF or scanned document. In these cases, OCR may be used in order to convert the document into a computer-readable text.

High-level rule file 210 may be converted into a low-level rule file 220. Low-level rule file may be readily interpreted by a verification program, and may be in the form of programming code. According to embodiments, the conversion may be performed using a machine learning model (e.g., such as a Large Language Model; LLM) in order to interpret high-level rule file 210. Low-level rule file 220 may specify, for example, what elements are permitted or not permitted to be included in the IDL file, or a boundary for values (e.g., array size limitations) in the IDL file. It should be appreciated that other types of rules may be included, depending on the specific implementation.

A verification program may be used in order to check low-level rule file 220 against IDL file 200 to see whether IDL file 200 complies with low-level rule file 220. It should be appreciated that according to some embodiments, the verification program may include the components/modules to convert high-level rule file 210 into low-level rule file 220, and the verification program may accept high-level rule file 210 as input along with IDL file 200 and perform the conversion.

If the verification program determines IDL file 200 complies with low-level rule file 220, a code generator may automatically generate the code based on the IDL file (e.g., to code language such as C, C++, etc.). On the other hand, if the verification program determines IDL file 200 does not comply with low-level rule file 220, an error/warning message may be sent to the user.

According to some embodiments, the user may provide feedback while testing the application after the code has been generated based on IDL file 200. For example, even if the verification program determined that IDL file is in compliance with low-level rule file 220, the user may determine that IDL file 200 is not in compliance. Accordingly, the user may opt to provide feedback to the system how to adjust the rules, this may be either the low-level rule file 220 (in the case that the user can read and understand the low-level rules) or high-level rule file 210 (in the case the high-level rules did not accurately reflect the safety standards in the first place). According to embodiments, the feedback may be used as training data to improve an ML model used to convert high-level rule file 210 to low-level rule file 220.

According to some embodiments, the conversion from high-level rule file 210 to low-level rule file 220 does not need to be performed each time code is generated. For example, if the same high-level rules which were already previously converted into a low-level rule file 220 are to be used again, the converted low-level rule file 220 may have been already cached, and after updated IDL file 200 is received, verification can be immediately performed using the cached low-level rule file.

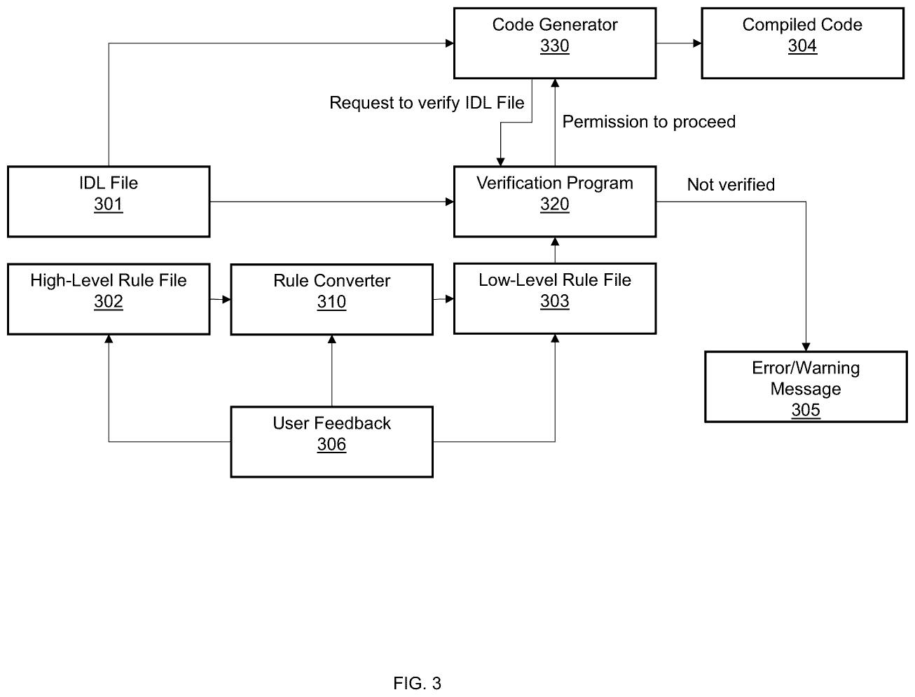

FIG. 3 is a block diagram showing an example system architecture for generating code based on an IDL file and rule files according to one or more example embodiments.

Files/data which may be provided are IDL file 301, high-level rule file 302, low-level rule file 303 (which may correspond to IDL file 200, high-level rule file 210, low-level rule file 220 described above respectfully), and user feedback 306. Files/data which may be generated are compiled code 304, and error/warning message 305.

Components and modules which may be provided are rule converter 310, verification program 320, and code generator 330. It should be appreciated that while the components and modules are illustrated in FIG. 3 as separate elements, some components may be combined (for example, rule converter 310 and verification program 320 could be consolidated into a single component).

At the outset, IDL file 301 may be provided. IDL file 301 may be received by both verification program 320 and code generator 330. Code generator 330 may provide a request to verification program 320 to verify the IDL file. Verification program 320 may proceed to obtain to request low-level rule file 303.

In the case where low-level rule file 303 has not already been generated, high-level rule file 302 is provided to rule converter 310, which may convert (for example, using an LLM model) high-level rule file 302 to low-level rule file 303. Alternatively, if low-level rule file 303 was already generated and no new high-level rule file 302 is provided a cached copy may be provided to verification program 320. Thereafter, verification program 320 may check based on low-level rule file 303 whether or not IDL file 301 is in compliance with low-level rule file 303.

In the case where the IDL file 301 is determined based on verification program 320 to be in compliance with low-level rule file 303, permission to proceed is given to code generator 330 to generate compiled code 304 based on IDL file 301.

In the case where the IDL file 301 is determined based on verification program 320 to not be in compliance with low-level rule file 304, warning/error message 305 is generated and returned to the user. For example, warning/error message 305 may list which rules were not complied with.

According to some embodiments, the user may provide user feedback 306 based on the result of the verification. In some cases, user feedback 306 may be used to directly edit high-level rule file 302. In some cases, user feedback 306 may be used to directly edit low-level rule file 303. Further, in the case where rule converter 310 operates using a ML model/LLM, the user feedback 306 may be used as training data in order to train/refine the operation of rule converter 310.

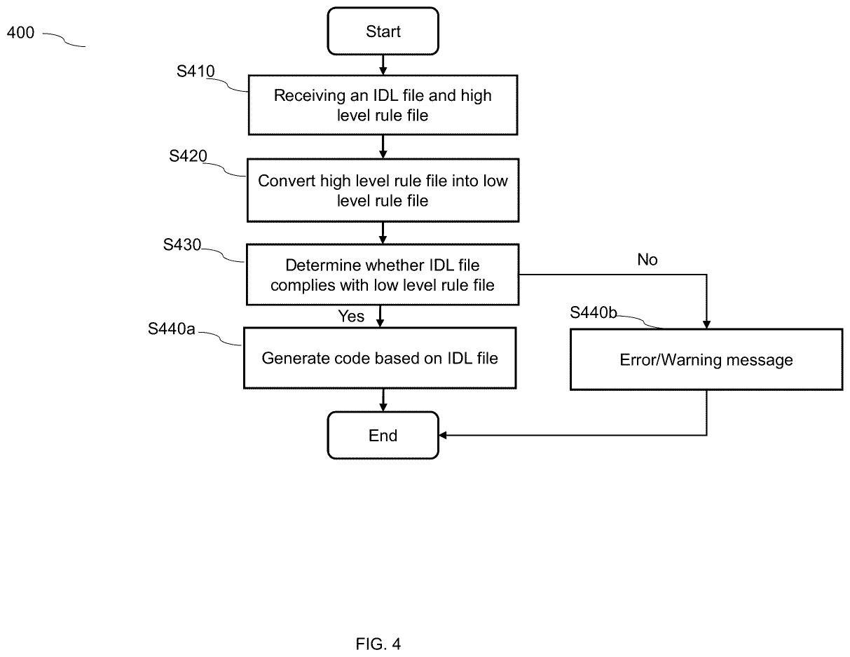

FIG. 4 is a flowchart diagram showing a method 400 generating code based on an IDL file and rule file according to one or more example embodiments.

At operation S410, an IDL file and high-level rule file may be received. According to embodiments, the IDL file may comprise at least one data-type or interface with dynamic memory allocation.

At operation S420, the high-level rule file may be converted into the low-level rule file (e.g., using a rule converter such as rule converter 310 above). According to embodiments, the conversion may be performed using a machine learning (ML) model. The high-level rule file may comprise a safety standard document. The low-level rule file may comprise at least one rule or an element or a combination of elements which cannot be included in the IDL file. In addition, the low-level rule file may comprise at least one rule or a boundary which cannot be exceeded in the IDL file.

At operation S430, it may be determined as to whether or not IDL file complies with the low-level rule file (e.g., using a verification program such as verification program 320 above)

At operation S440a, if S430 was determined to be “yes”, code is generated based on the IDL file (e.g., using a code generator such as code generator 330).

At operation S440b, if S430 was determined to be “no”, an error/warning message is generated and returned to the user.

Based on the above, it can be understood that by using dynamic memory allocation for data types/interfaces in the IDL file, safety-critical scenarios which require a specific data precision/number of data points can be encompassed. In addition, since more abstract rules (which may encompass a safety standard) can be defined in a high-level rule file, the user can more easily map the IDL file to be in compliance with their ruleset.

The foregoing disclosure provides illustration and description, but is not intended to be exhaustive or to limit one or more example embodiments to the precise form disclosed. Modifications and variations are possible in light of the disclosure or may be acquired from practice of one or more example embodiments.

One or more example embodiments may relate to a system, a method, and/or a computer readable medium at any possible technical detail level of integration. Further, one or more of the components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand- alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more example embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible example embodiments of systems, methods, and computer readable media according to one or more example embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the drawings. In one or more alternative example embodiments, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of one or more example embodiments. Thus, the operation and behavior of the systems and/or methods were described herein without reference to specific software code—it being understood that software and hardware may be designed to implement the systems and/or methods based on the description herein.

What is claimed is:

1. A method for generating codes, the method comprising:
receiving, by a code-generating apparatus, an interface definition language (IDL) file and a high-level rule file;
converting, by the code-generating apparatus, the high-level rule file into a low- level rule file;
determining, by the code-generating apparatus, whether the IDL file complies with the low-level rule file; and
based on determining that the IDL file complies with the low-level rule file, generating, by the code-generating apparatus, code based on the IDL file.

2. The method of claim 1, wherein the IDL file comprises at least one data-type or interface with dynamic memory allocation.

3. The method of claim 1, wherein converting the high-level rule file into a low- level rule file comprises interpreting the high-level rule file using a machine learning model.

4. The method of claim 1, wherein the high-level rule file comprises a safety standard document.

5. The method of claim 1, wherein the low-level rule file comprises at least one rule of an element or a combination of elements which cannot be included in the IDL file.

6. The method of claim 1, wherein the low-level rule file comprises at least one rule of a boundary which cannot be exceeded in the IDL file.

7. The method of claim 1, further comprising:
based on determining that the IDL file does not comply with the low-level rule file, sending a warning message. 8 An apparatus for generating codes, the apparatus comprising:
at least one memory storing computer-executable instructions; and
at least one processor configured to execute the computer-executable instructions to:
receive an interface definition language (IDL) file and a high-level rule file;
convert the high-level rule file into a low-level rule file;
determine whether the IDL file complies with the low-level rule file; and
based on determining that the IDL file complies with the low-level rule file, generate code based on the IDL file.

9. The apparatus of claim 8, wherein the IDL file comprises at least one data-type or interface with dynamic memory allocation.

10. The apparatus of claim 8, wherein the at least one processor is configured to convert the high-level rule file into a low-level rule file by interpreting the high-level rule file using a machine learning model.

11. The apparatus of claim 8, wherein the high-level rule file comprises a safety standard document.

12. The apparatus of claim 8, wherein the low-level rule file comprises at least one rule of an element or a combination of elements which cannot be included in the IDL file.

13. The apparatus of claim 8, wherein the low-level rule file comprises at least one rule of a boundary which cannot be exceeded in the IDL file.

14. The apparatus of claim 8, wherein the at least one processor is further configured to execute the computer-executable instructions to: based on determining that the IDL file does not comply with the low-level rule file, send a warning message.

15. A non-transitory computer-readable recording medium having recorded thereon instructions to perform a method for generating codes, the method comprising:
receiving an interface definition language (IDL) file and a high-level rule file;
converting the high-level rule file into a low-level rule file;
determining whether the IDL file complies with the low-level rule file; and
based on determining that the IDL file complies with the low-level rule file, generating code based on the IDL file.

16. The non-transitory computer-readable recording medium of claim 15, wherein the IDL file comprises at least one data-type or interface with dynamic memory allocation.

17. The non-transitory computer-readable recording medium of claim 15, wherein converting the high-level rule file into a low-level rule file comprises interpreting the high-level rule file using a machine learning model.

18. The non-transitory computer-readable recording medium of claim 15, wherein the high-level rule file comprises a safety standard document.

19. The non-transitory computer-readable recording medium of claim 15, wherein the low-level rule file comprises at least one rule of an element or a combination of elements which cannot be included in the IDL file.

20. The non-transitory computer-readable recording medium of claim 15, wherein the low-level rule file comprises at least one rule of a boundary which cannot be exceeded in the IDL file.
